(19) United States
(12) Patent Application Publication
(10) Pub. No.: US 2012/0279648 A1
(43) Pub. Date: Nov. 8, 2012

(54) PREPARING METHOD FOR INTEGRATED MEMBRANE-CATALYST COATED LAYER MEMBRANE ELECTRODE FOR A FUEL CELL

(76) Inventors: Zhongjun Hou, Dalian (CN); Pingwen Ming, Dalian (CN); Danmin Xing, Dalian (CN); Shufan Song, Dalian (CN); Ke Zhang, Dalian (CN); Yuhai Zhang, Dalian (CN)

(21) Appl. No.: 13/394,142

(22) PCT Filed: Jun. 3, 2010
(86) PCT No.: PCT/CN10/73485

§ 371 Date: Mar. 3, 2012

(30) Foreign Application Priority Data
Apr. 9, 2010 (CN) 201010144010.4

(51) Int. Cl. H01M 4/88; B32B 38/00

(52) U.S. Cl. 156/280; 427/115

(57) ABSTRACT

An integrated method for preparing a fuel cell membrane-catalyst coated membrane electrode, comprising preparation a proto exchange membrane and preparing catalyst coated membrane electrode, characterized in that: the proton exchange membrane is prepared by casting, dipping or spraying proton exchange resin solution (401) to obtain a precursor without post-treatment; the catalyst coated membrane electrode (CCM), is produced by directly coating electrode slurry on both sides of precursor of proton exchange membrane using a method chosen from screen-printing, spraying or brushing, and drying to obtain a CCM precursor with stable morphology; and treating the CCM precursor with ion transformation, heat and activation. The membrane electrode assembly preparation method in the present invention has the following characteristics: simplified preparation process, easy to scale up production, high electrochemical activity, good mechanical strength and stable structure morphology of the prepared membrane electrode assembly.

### FIELD OF THE INVENTION

The present invention relates to fuel cell field, and, more particularly, to preparation method for catalyst coated membrane electrode for fuel cells, especially, an integration method for preparing proton exchange membrane and catalyst coated membrane electrode.

### BACKGROUND OF THE INVENTION

Membrane and electrode assembly (MEA) mainly consists of cathode electrode, anode electrode and proton exchange membrane. Cathode and anode electrodes composed of gas diffusion layer (GDL) and catalyst layer (CL). MEA provides a location for completing conversion from chemical energy to electrical energy, so it undertakes supply of fuel and oxidant, export of electronic and water, etc. In order to improve the efficiency of electrochemical reaction and reduce the amount of catalyst, MEAs with various structures have been developed, and their main difference lies in the electrode structure, which can be roughly divided into thick gas diffusion electrode (GDE) and thin hydrophilic electrode. Traditional MEA is prepared as follows: firstly preparing catalyst layer onto porous gas diffusion layer to form gas diffusion electrode, and then hot-pressing two pieces of electrodes onto both sides of proton exchange membrane to form a MEA. The catalyst layer of this kind of MEA is rather thick and required amount of catalyst is rather great, and the combination of catalyst layer and membrane is poor. In order to improve fuel cell efficiency and reduce catalyst amount, Wilson et al. (“Thin film catalyst layers for polymer electrolyte fuel cell electrode” by M. S. Wilson and S. Gottesfeld, Journal of Applied Electrochemistry 1992, 22: 1-7, “High performance catalyzed membranes of ultra-low PT loadings” by M. S. Wilson and S. Gottesfeld, Journal of Electrochem. Soc., 1992, 139(2): L28-L30) proposed to prepare catalyst layer on proton exchange membrane, and then laminate it with gas diffusion layers (GDLs) together to form a MEA. From the preparation process point of view, it is called as a catalyst coated membrane electrode (CCM). Form the electrode structure characteristics, it belongs to thin hydrophilic electrode.

Thin-layer hydrophilic electrode mainly contains two kinds of components: one component is catalyst, such as Pt/C, which plays a role to provide activity for electrochemical reaction and conduct electron. The other one component is ionomer, such as perfluorinated sulfonate acid resin, and the network from by the ionomer plays a role of proton conduction. In order to improve catalyst dispersion and optimize electrode structure, some agents such as dispersant, binder, pore-forming agent or hydrophobic agent, etc. can be added in electrode slurry for electrode preparation according to the requirement. For example, as described in U.S. Pat. No. 5,330,860, and incorporated herein by reference, the electrode slurry contains catalyst (Pt/C), ionomer (perfluorinated sulfonic acid polymer) and dispersant (ethylene glycol monomethyl ether). As described in U.S. Pat. No. 5,211,984, ethylene glycol or sodium hydroxide (NaOH) is used to adjust the viscosity of electrode slurry. The dense catalyst layer prepared using these electrode slurries is completely hydrophilic and has continuous proton conduction path. The combination of catalyst layer and membrane is very good and beneficial for proton and water transfer. It is also because of this, in order to ensure adequate gas (fuel and oxidant) to reach the catalyst surface and achieve electrochemical reaction, the requirement of such hydrophilic catalyst layer must be very thin, therefore, it is very important to ensure uniform dispersion of catalyst particles.

The existing technologies for CCM preparation are mainly divided into direct and indirect methods. Direct method is dispersing catalyst slurry onto proton exchange membrane to form CCM, for example, the open method in China Pat. CN 200,410,012,745.6 is blending catalyst with proton exchange resin, hydrophobic agent, dispersant and surfactant agent to prepare electrode power, and dispersing the electrode powder onto proton exchange membrane to form CCM by laser printing and xerography technology. The open method in U.S. Pat. No. 6,074,692 is pre-swelling proton exchange membrane, fixing the membrane with equipment to limit contraction, and then distributing electrode slurry onto both sides of proton exchange membrane by spraying method, and drying to form CCM. The open method in U.S. Pat. No. 7,041,191 is fixing proton exchange membrane on a substrate, placing the substrate on a screen printing machine, and then screen-printing electrode slurry onto both sides of proton exchange membrane, and then forming CCM by drying and hot-pressing. The open method in U.S. Pat. No. 7,285,307 is making proton exchange membrane and a plastic back film together, and dispersing electrode slurry on one side of proton exchange membrane by screen-printing or stencil printing method, after drying electrode slurry completely, peeling off the back film, and distributing electrode slurry on the other side of proton exchange membrane with the method as described previously.

Indirect method is coating electrode slurry on substrate media to form catalyst layer, then transferring the catalyst layer onto proton exchange membrane by hot-pressing method. For example, the open method in U.S. Pat. No. 5,211,984 is coating catalyst and ionomer slurry with suitable viscosity on the substrate medium-Teflon film, and drying to form catalyst layer, then pasting it with proton exchange membrane and making strong combination of catalyst layer and membrane by hot-pressing, finally peeling off PTFE microporous film. The open method in U.S. Pat. No. 5,211,984 is pre-treating PTFE microporous film with diluted Nafion solution, followed with coating electrode slurry on it, after drying solvent completely, pasting catalyst layer and proton exchange membrane together and making strong combination of catalyst layer and membrane by hot pressing, then peeling off PTFE microporous film. As described in China Pat. CN 200,410,012,744.1, electrode slurry is coated on substrate medium by screen-printing technology to form catalyst layer, and then catalyst layer is transferred onto proton exchange membrane by hot-pressing.

Because the scale and efficiency of MEA preparation process is an important factor to restricting fuel cell capacity, development of simplified and batch production technology of catalyst coated membrane electrode is an objective for fuel cell manufactures to pursue. The open and continuous CCM preparation method in U.S. Pat. No. 6,823,584 is combining membrane and electrode together using double-sided pressure equipment, and cutting out CCM to a certain size using a variety of cutting techniques.

In summary, all the methods of the existing technologies use as-received proton exchange membrane to prepare CCM, that is to say, proton exchange membrane and electrode are prepared separately. For this kind of preparation process, route is relatively complicated, and is not conducive to reduce cost, especially not conducive for mass manufacturing.

### CONTENT OF INVENTION

The present disclosure presents a method for preparing catalyst coated membrane electrode (CCM) by integrating the preparation of proton exchange membrane and preparation of electrode preparation.

Technology solutions of the present invention are implemented as follows:

An integrated method for preparing a fuel cell membrane-catalyst coated membrane electrode, comprising preparation a proto exchange membrane and preparing catalyst coated membrane electrode, characterized in that:

the proton exchange membrane is prepared by casting, dipping or spraying proton exchange resin solution, then drying to obtain a precursor of proton exchange membrane without post-treatment;

the catalyst coated membrane electrode, namely CCM, is produced by directly coating electrode slurry on both sides of precursor of proton exchange membrane using a method chosen from screen-printing, spraying or brushing, and drying to obtain a CCM precursor with stable morphology; and

treating the CCM precursor with ion transformation, heat and activation.

Said drying of the proton exchange resin solution membrane is: heating and drying the resin solution membrane at a temperature ranging from 50 to 150° C. to remove a solvent in the process of coating resin solution for forming a membrane, and then obtaining precursor of proton exchange membrane.

Said heating and drying of the proton exchange resin solution membrane is accomplished using hot-plate heating.

Said drying of electrode slurry in the process of CCM production is: heating and drying the electrode slurry at a temperature ranging from 50 to 150° C. to remove a solvent in electrode slurry in the process of coating electrode slurry onto both sides of precursor of proton exchange membrane, and then obtaining CCM precursor with stable morphology.

Said heating and drying of electrode slurry is accomplished using hot-plate heating.

Said the structure of precursor of proton exchange membrane is either homogeneous or composite.

Said preparation of precursor of proton exchange membrane with homogeneous structure is: casting or spraying proton exchange resin solution on the substrate sheet; and heating and drying simultaneously to remove solvent in the proton exchange resin solution; then obtaining a continuous precursor of proton exchange membrane, wherein said substrate sheet for preparing precursor of proton exchange membrane with homogeneous structure is stainless steel track or plastic film.

Said preparation of precursor of proton exchange membrane with composite structure is: using unfolded microporous film or fabric as composite substrate, coating and pasting proton exchange resin solution on the composite substrate; and heating and drying simultaneously to remove solvent; then obtaining a precursor of proton exchange membrane with stable morphology is obtained, wherein said composite substrate for preparing precursor of proton exchange membrane with composite structure is microporous film or fabric.

Said preparation of CCM precursor using a precursor of proton exchange membrane with homogenous structure is: firstly coating electrode slurry onto one side of membrane precursor and drying, and then peeling substrate film track off; and turning precursor of the membrane with electrode on one side over and coating the electrode slurry onto the other side and drying.

Said preparation of CCM precursor using precursor of proton exchange membrane with composite structure is: firstly coating the electrode slurry onto one side of the membrane precursor, and then turning the membrane precursor over and coating electrode slurry onto the other side and drying; or

Coating the electrode slurry simultaneously onto both sides of membrane precursor and dried.

Said ion transformation treatment comprising: immersing CCM precursor in alkaline solution or salt solution for 0.5˜2 hours to convert ion exchange resin in electrode layer to a non-H⁺ form at a temperature ranging from room temperature and 100° C., wherein said alkaline solution is a NaOH solution or a KOH solution; and said salt solution is saturated NaCl solution or KCl solution.

Said heat treatment of CCM precursor comprising: heating CCM precursor after ion transformation treatment at 100-250° C. for 3˜5 hours in an inert atmosphere.

Said activation treatment comprising: immersing CCM precursor in 0.1˜1 M sulfuric acid solution and washing with water to convert proton exchange membrane and resin of CCM precursor to a H⁺ form.

In most prior embodiment, method of preparing a CCM, using proton exchange membrane with homogenous structure or composite structure, characterized in that,

Said production process of CCM using proton exchange membrane with homogenous structure comprising:
1) Placing prepared proton exchange resin solution in a proton exchange resin solution tank.
2) Placing prepared electrode slurry in a slurry spraying tank.
3) transferring the stainless steel plate using a roller transportation device to a coating zone, wherein the proton exchange resin solution in the proton exchange resin solution tank is transferred onto the stainless steel plate through a pouring trough, and the proton exchange resin solution is evenly applied on the stainless steel track using a paddle scraper;
4) transferring the stainless steel plate coated with proton exchange resin solution to a heating channel to evaporate a solvent in the proton exchange resin solution to obtain the precursor of the proton exchange membrane;
5) separating the precursor of the proton exchange membrane from the stainless steel plate; transferring the precursor of the proton exchange membrane to a spraying equipment wherein the electrode slurry is sprayed onto both sides of the precursor of the proton exchange membrane;
6) the precursor of the proton exchange membrane with the electrode slurry on both sides is heated and dried to form CCM precursor;
7) immersing the CCM precursor in a NaCl solution, then washing with de-ionized water, and further removing liquid on the surface of the CCM precursor with a water-absorbing roller;
8) heating and drying the CCM precursor in a nitrogen atmosphere; and
9) immersing the CCM precursor in a sulfuric acid solution, washing with de-ionized water, and further removing liquid on the surface of CCM precursor to obtain a CCM electrode with homogenous structure.

Said production process of CCM using proton exchange membrane with composite structure comprising:
1) placing the proton exchange resin solution in a proton exchange resin solution tank of a spraying equipment;
2) Placing a prepared diluted proton exchange resin solution in a diluted proton exchange resin solution tank;
3) placing the prepared electrode slurry in an electrode material slurry tank of spraying equipment;
4) affixing a microporous PTFE film on a supporting frame;
5) immersing the supporting frame affixed with the microporous PTFE film in diluted proton exchange resin solution, followed by drying on a hot plate;
6) spraying the proton exchange resin solution evenly on both sides of the microporous film affixed on the supporting frame using the spraying equipment until the thickness of the proton exchange resin of the microporous PTFE film reaches a pre-determined value to obtain the precursor of the proton exchange membrane, wherein the temperature of hot plate is maintained;
7) spraying the electrode slurry onto both sides of the precursor of the proton exchange membrane using electrode slurry spraying equipment until the thickness of an electrode material layer reaches a pre-determined value to obtain the CCM precursor, wherein the temperature of hot plate is maintained;
8) removing the CCM precursor from the supporting frame and immersing it in a NaOH solution, washing with de-ionized water, and removing liquid on the surface to obtain precursor of CCM in a Na⁺ form;
9) heating and drying the CCM precursor in nitrogen; and
10) immersing the CCM precursor in a sulfuric acid solution, washing with de-ionized water, and removing the liquid on its surface to obtain CCM electrode with composite structure.

The method for preparing CCM in the present invention has the following characteristics:
1) Use of precursor of proton exchange membrane for preparing CCM eliminates membrane pre-treatment and post-treatment process, and integrates membrane and membrane-electrode preparation, which simplifies preparation process, and is particularly conducive for batch manufacturing and improving production efficiency and reducing costs.
2) Use of precursor of proton exchange membrane for preparing CCM helps to improve combination of membrane and electrode, and increase electrode activity and stability.
3) Use of ion transformation and heat treatment process helps to improve electrochemical activity and mechanical strength of CCM.

### BRIEF DESCRIPTION OF THE DRAWINGS

There are five drawings in the present invention.

FIG. 1 is preparation process diagram of embodiment 1 in the present invention

FIG. 2 is schematic diagram of prepared CCM of embodiment 1 in the present invention.

FIG. 3 is performance curves of fuel cell assembled using prepared CCM of embodiment 1 in the present invention.

FIG. 4 is preparation process diagram of embodiment 2 in the present invention.

FIG. 5 is schematic diagram of prepared CCM of embodiment 2 in the invention.

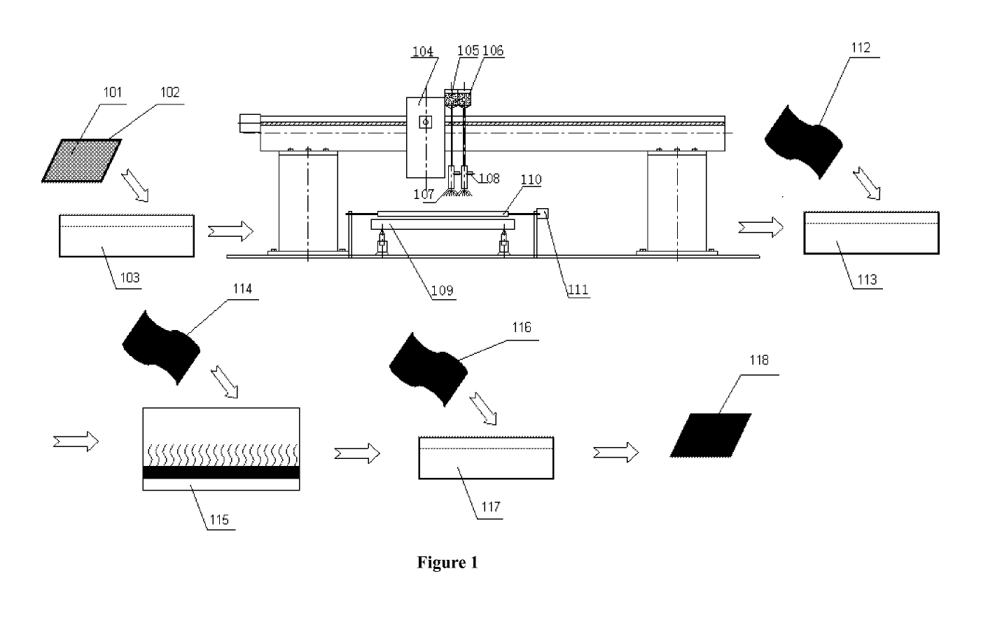

In the drawings, 101, PTFE microporous film; 102, supporting frame; 103, diluted proton exchange resin solution for preparing catalyst coated membrane using precursor of proton exchange membrane with composite structure; 104, mechanical arm; 105, proton exchange resin solution for preparing CCM using precursor of proton exchange membrane with composite structure; 106, electrode slurry for preparing CCM using precursor of proton exchange membrane with composite structure; 107, proton exchange resin solution spraying equipment; 108, electrode slurry spraying equipment; 109, hot plate; 110, steel frame on the hot plate; 111, motor; 112, CCM precursor; 113, NaOH solution; 114, CCM precursor in a Na⁺ form; 115, oven; 116, pre-preparation form of CCM; 117, 0.5 M sulfuric acid; 118, CCM prepared using precursor of proton exchange membrane with composite structure; 202, precursor of proton exchange membrane with composite structure; 201a, electrode layer; 201b, electrode layer; 401, proton exchange resin solution; 402, stainless steel track; 403, baffle scraper; 404, heating channel; 405, precursor of proton exchange membrane with homogeneous structure; 406a, electrode slurry; 406b, electrode slurry; 407, spraying equipment; 408, hot plate; 409, hot plate; 410, spraying equipment; 411, precursor of CCM coated with electrode layer; 412, NaCl solution trough; 413, de-ionized water trough; 414, water-absorbing roller; 415, drying channel; 416, pre-preparation form of CCM; 501a, electrode layer; 501b, electrode layer; 502, proton exchange membrane with homogenous structure.

### DESCRIPTION OF THE PREFERRED EMBODIMENT

The integration method for preparing membrane-catalyst coated membrane electrode for fuel cell in the present invention comprises preparation of precursor of proton exchange membrane and catalyst coated membrane electrode (CCM), ion transformation, heat and activation treatments of CCM precursor.

Preparation process of precursor of proton exchange membrane is as follows: proton exchange membrane is coated on substrate film sheet by casting, dipping or spraying proton exchange resin solution, and precursor of proton exchange membrane is obtained after heating and drying to remove solvent. Used proton exchange resin solution consists of proton exchange resin and solvent. The content of proton exchange resin in proton exchange resin solution is 3˜20 wt. %. Proton exchange resins can be one of perfluorinated, partially florinated sulfonic acid resin and fluorine resin, solvent can be one kind of solvent or mixed solvents, including alcohols, water and high-boiling point polar solvents. Alcohols can be one or several kinds of methanol, ethanol, propanol, isopropanol and n-butanol, high-boiling-point solvent can be one or several kinds of N,N-dimethylformamide, N,N-dimethylacetamide, dimethyl sulfoxide and 1-methyl-2-pyrrolidone. Precursor structure of proton exchange membrane can be either homogenous or composite. The substrate sheet for preparing precursor of proton exchange membrane with homogenous structure is either stainless steel track or plastic film. The substrate for preparing precursor of proton exchange membrane with composite structure is either microporous film or fabric, Membrane transport can be used with roller with fixing apparatus or supporting frame. Drying of precursor of proton exchange membrane is simultaneously conducted by hot-plate heating in the process of coating proton exchange resin, and the temperature is between 50 and 150° C.

Preparation process of CCM precursor is as follows: electrode slurry is coated onto both sides of precursor of proton exchange membrane by screen-printing, spraying or brushing methods, at the same time, heated and dried to remove solvent of electrode slurry to form CCM precursor with stable morphology. Electrode slurry consists of electro-catalyst, proton exchange resin and dispersant. Electro-catalyst is supported catalyst, and catalyst support is one or several kinds of carbon black, carbon nanotube, carbon should, TiO₂, and the like. Active component in the catalyst is one or several kinds of Pt, Pt—Pd, Pt—Ru, etc., and the loading of active component is 20-70 wt. %. Proton exchange resin in electrode slurry is one kind of perfluorinated, partially fluorinated sulfonic acid resin, and fluorine resin. Dispersant in electrode slurry is one or several kinds of water, alcohol, esters and ethers. Drying of CCM precursor is simultaneously conducted in the process of coating electrode slurry by hot-plate heating, and the temperature is between 50-150° C. When CCM is prepared using precursor of proton exchange membrane with homogenous structure, electrode slurry is coated on one side of the membrane precursor and dried, and then the substrate film sheet is peeled off and the membrane precursor is turned over, and electrode slurry is coated on the other side of the membrane precursor and dried. When CCM is prepared using precursor of proton exchange membrane with composite structure, electrode slurry can be coated on both sides of membrane separately or simultaneously. CCM formation in the present invention is completed by ion transformation, heat and activation treatment of CCM precursor. Ion transformation is immersing CCM precursor into alkaline or salt solution to make ion exchange resin convert into a non-H⁺ form, alkaline solution is NaOH or KOH solution, salt solution is saturated NaCl or KCl solution, immersing temperature is between room temperature and 100° C., and immersing time is 0.5˜2 hours. Heat treatment is placing CCM precursor after ion transformation in an oven at 100-250° C. under inert atmosphere and maintaining that temperature for 2˜5 hours. Activation treatment is immersing CCM precursor in 0.1˜1M sulfuric acid solution and washing with water to convert proton exchange membrane and resin in CCM precursor to a H⁺ form.

### Embodiment 1

CCM is prepared using precursor of proton exchange membrane with composite structure, and specific preparation procedures are as follows:
1. Preparation of proton exchange resin solution 105: a certain amount of N,N-dimethyl acetamide is added into 5 wt. % perfluorinated sulfonic acid resin solution, then the mixture is ultrasonically agitated for use in the following procedure. The solvent system of perfluorinated sulfonic acid resin solution consists of n-propanol and water. The mass ratio of N,N-dimethyl acetamide to proton exchange resin solution is 1:1.
2. Preparation of diluted proton exchange resin solution 103: 5 wt. % perfluorinated sulfonic acid resin solution is diluted with solvent to 1 wt. %, then a certain amount of N,N-dimethyl acetamide is added and ultrasonically agitated for use in the following procedure. The mass ratio of N,N-dimethylacetamide to proton exchange resin is 2:1.
3. Preparation of electrode slurry 106: 70 wt. % Pt/C catalyst, 5 wt. % perfluorinated sulfonic acid resin solution and isopropyl alcohol dispersant are weighed and placed in a weighting bottle, in which the mass ratio of catalyst to perfluorinated sulfonic acid resin is 2:1, and the mass ratio of catalyst to dispersant is 1:300. The above materials are placed in ultrasonic generator and ultrasonically agitated for 30 min to form electrode slurry.
4. PTFE microporous film 101 is fixed in the supporting frame 102.
5. The supporting frame with microporous film is infiltrated in diluted solution 103 for 15 min and then moved out for drying on hot plate at 90° C.
6. Spraying equipment 107 is started to evenly spray proton exchange resin solution 105 onto both sides of microporous film 110 fixed in supporting frame, respectively, at the same time, the temperature of hot plate 109 is kept at 90˜120° C. Spraying is repeated until the membrane thickness reaches the scheduled requirement to form membrane precursor.
7. Spraying equipment 108 is started to evenly spray electrode slurry 106 onto both sides of membrane precursor, at the same time, the temperature of hot plate 109 is kept at 90˜120° C. Spraying is repeated until the membrane thickness reaches the scheduled requirement to form CCM precursor.
8. CCM precursor 112 is removed from supporting frame, and immersed in 1 wt. % NaOH solution 113 at 80° C. for 1 h. The CCM precursor is washed repeatedly with de-ionized water. After removing the liquid on the surface, CCM precursor in a Na⁺ form 114 is obtained.
9. CCM precursor in a Na⁺ form is placed in oven 115 at 140° C. and dried for 4 hours under N₂ atmosphere, and then pre-preparation form of CCM 116 is obtained.
10. The pre-preparation form of CCM 116 is immersed in 0.5 M sulfuric acid solution at 80° C. for 1 hour and washed repeatedly with de-ionized water. After removing the liquid on the surface, composite CCM 118 is obtained.

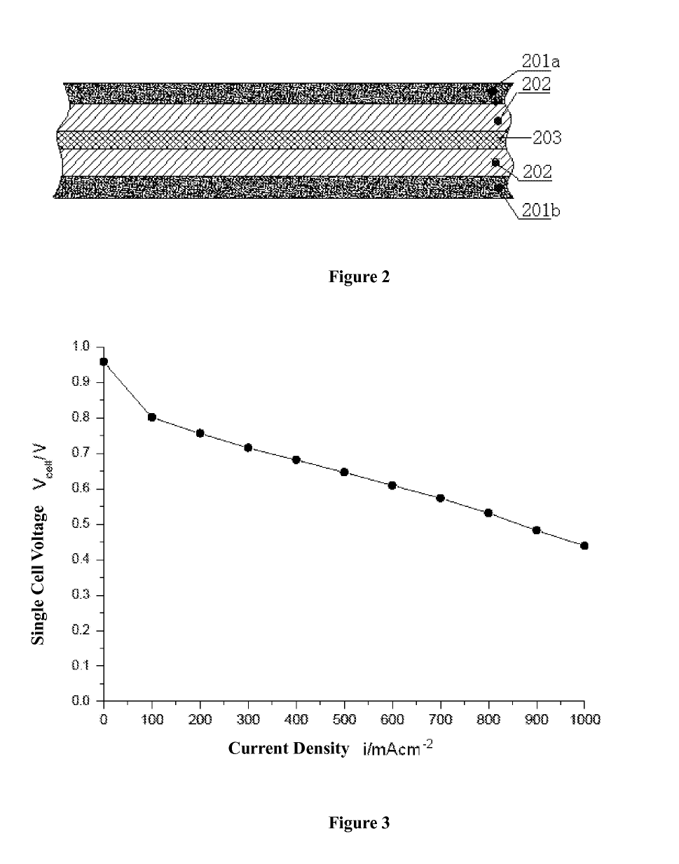

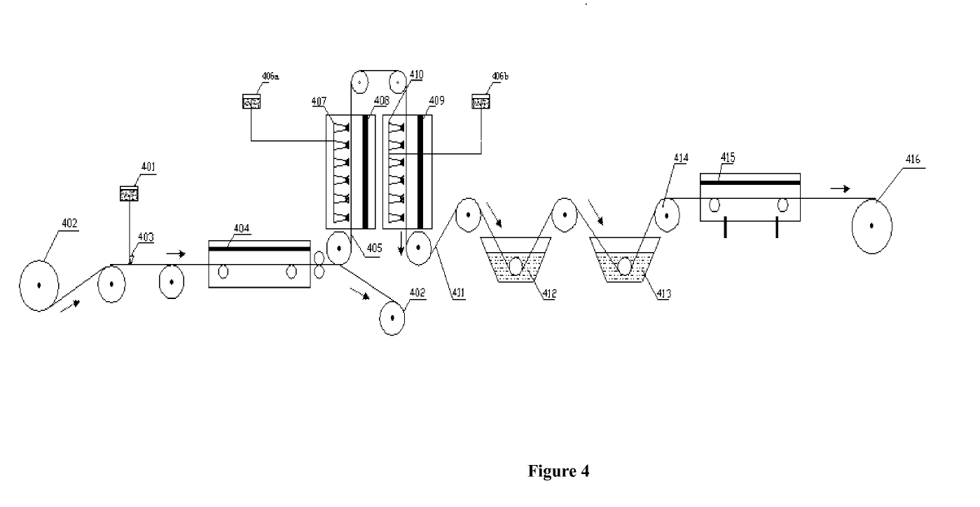

The structure of composite CCM prepared according to the above steps is shown in FIG. 2. Membrane precursor is composite membrane precursor 202+203, and the thickness is 10-100 μm, the thickness of electrode layer 201a and 201b is 3-10 um, respectively, the catalyst loading of electrode layer is 0.4˜0.05 mg Pt/cm². CCM and two piece of gas diffusion layers is laminated together to prepare CCM components, and assembled in fuel cell, and its performance is shown in FIG. 3. The test conditions are as follows: the active area of electrode is 35 cm², working gas is H₂ and air at atmospheric pressure, and the relative humidity is 100% and cell temperature is 60° C.

### Embodiment 2

CCM is prepared using precursor of proton exchange membrane using homogenous structure, and specific preparation procedures are as follows:
1. Preparation of proton exchange resin solution 401: sulfonated polyphenylene ether sulfone is dissolved in mixed solvents of N,N-dimethylacetamide and tetrahydrofuran, in which the content of sulfonated polyphenylene ether sulfone is 15 wt. % and the mass ratio of N,N-dimethylacetamide to tetrahydrofuran is 2:1.
2. Preparation of electrode slurry 406: 40 wt. % Pt/C catalyst, 5 wt. % perfluorinated sulfonic acid, ethylene glycol and isopropanol dispersant are weighed and placed in a weighing bottle, in which the mass ratio of catalyst to perfluorinated sulfonic acid resin is 3.5:1, the mass ratio of catalyst to dispersant is 1:300, and the mass ratio of ethylene glycol to iso-propanol in the dispersant is 1:5. The above materials are placed in ultrasonic generator and ultrasonically agitated for 30 min to form electrode slurry.
3. Stainless steel track 402 is transported by a roller to the working zone of the coating machine, and the proton exchange resin solution 401 prepared in step 1 is poured on the stainless steel track by pouring trough, followed with evenly distributing the solution on the stainless steel track by paddle scraper 403.
4. The stainless steel track coated with proton exchange resin solution is sent to heating channel 404, and the temperature is controlled at 60˜130° C. to make solvent evaporate, and then precursor with homogenous structure 405 is obtained.
5. After the precursor of membrane with homogenous structure is peeled off from stainless steel track and sent into spraying equipment 407, the spraying equipment 407 is started. The electrode slurry 406 prepared in step 2 is evenly dispersed on one side of membrane precursor, and the temperature of hot plate is maintained at 90˜120° C. to dry electrode slurry and form one-sided CCM precursor.
6. The one-sided CCM precursor is transported to spraying equipment 410 by another roller. Electrode slurry 406 prepared in step 2 is evenly dispersed on the other side of one-sided CCM precursor, and the temperature of hot plate is maintained at 90˜120° C. to dry electrode slurry and form double-sided CCM precursor.
7. The CCM precursor 411 is sent and immersed in a trough filled with 30 wt. % NaCl solution at 60° C., and then sent and washed in de-ionized water trough 413, and the liquid on the surface of CCM precursor is removed by water-absorbing roller 414.
8. The CCM precursor is sent to drying channel at 180° C., and dried under N₂ atmosphere, and then pre-preparation form of CCM 416 is obtained.
9. The pre-preparation form of CCM 416 is immersed in 0.5 M sulfonic acid at 80° C. for 1 hour, and washed repeatedly with de-ionized water. After removing the liquid on the surface, CCM with homogenous structure is obtained.

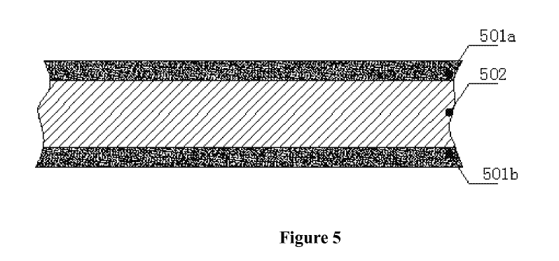

The structure of CCM prepared using the above process is shown in FIG. 5, the thickness of membrane precursor with homogenous structure 502 is 10˜100 μm, the thickness of electrode layer 501a and 501b is 3-15 μm, respectively, and the catalyst loading in the electrode is 0.4˜0.05 mg Pt/cm².

We claim:

1. An integrated method for preparing a fuel cell membrane-catalyst coated membrane electrode, comprising preparation a proto exchange membrane and preparing catalyst coated membrane electrode, characterized in that:
the proton exchange membrane is prepared by casting, dipping or spraying proton exchange resin solution, then drying to obtain a precursor of proton exchange membrane without post-treatment;
the catalyst coated membrane electrode, namely CCM, is produced by directly coating electrode slurry on both sides of precursor of proton exchange membrane using a method chosen from screen-printing, spraying or brushing, and drying to obtain a CCM precursor with stable morphology; and
treating the CCM precursor with ion transformation, heat and activation.

2. The method according to claim 1, wherein said drying of the proton exchange resin solution membrane is: heating and drying the resin solution membrane at a temperature ranging from 50 to 150° C. to remove a solvent in the process of coating resin solution for forming a membrane, and then obtaining precursor of proton exchange membrane.

3. The method according to claim 2, wherein said heating and drying of the proton exchange resin solution membrane is accomplished using hot-plate heating.

4. The method according to claim 1, wherein said drying of electrode slurry in the process of CCM production is: heating and drying the electrode slurry at a temperature ranging from 50 to 150° C. to remove a solvent in electrode slurry in the process of coating electrode slurry onto both sides of precursor of proton exchange membrane, and then obtaining CCM precursor with stable morphology.

5. The method according to claim 4, wherein said heating and drying of electrode slurry is accomplished using hot-plate heating.

6. The method according to claim 1, wherein said the structure of precursor of proton exchange membrane is either homogeneous or composite.

7. The method according to claim 6, wherein
said preparation of precursor of proton exchange membrane with homogeneous structure is: casting or spraying proton exchange resin solution on the substrate sheet; and heating and drying simultaneously to remove solvent in the proton exchange resin solution; then obtaining a continuous precursor of proton exchange membrane.
said preparation of precursor of proton exchange membrane with composite structure is:
using unfolded microporous film or fabric as composite substrate, coating and pasting proton exchange resin solution on the composite substrate; and heating and drying simultaneously to remove solvent; then obtaining a precursor of proton exchange membrane with stable morphology is obtained.

8. The method according to claim 7, wherein said substrate sheet for preparing precursor of proton exchange membrane with homogeneous structure is stainless steel track or plastic film; wherein said composite substrate for preparing precursor of proton exchange membrane with composite structure is microporous film or fabric.

9. The method according to claim 6, wherein
said preparation of CCM precursor using a precursor of proton exchange membrane with homogenous structure is: firstly coating electrode slurry onto one side of membrane precursor and drying, and then peeling substrate film track off; and turning precursor of the membrane with electrode on one side over and coating the electrode slurry onto the other side and drying.
wherein said preparation of CCM precursor using precursor of proton exchange membrane with composite structure is: firstly coating the electrode slurry onto one side of the membrane precursor, and then turning the membrane precursor over and coating electrode slurry onto the other side and drying; or
coating the electrode slurry simultaneously onto both sides of membrane precursor and dried.

10. The method according to claim 1, characterized in that:
said ion transformation treatment comprising: immersing CCM precursor in alkaline solution or salt solution for 0.5˜2 hours to convert ion exchange resin in electrode layer to a non-H⁺ form at a temperature ranging from room temperature and 100° C., wherein said alkaline solution is a NaOH solution or a KOH solution; and said salt solution is saturated NaCl solution or KCl solution.
said heat treatment of CCM precursor comprising: heating CCM precursor after ion transformation treatment at 100-250° C. for 3˜5 hours in an inert atmosphere.
said activation treatment comprising: immersing CCM precursor in 0.1˜1 M sulfuric acid solution and washing with water to convert proton exchange membrane and resin of CCM precursor to a H⁺ form.

11. The method according to claim 1, using proton exchange membrane with homogenous structure or composite structure, characterized in that,
said production process of CCM using proton exchange membrane with homogenous structure comprising:
1) Placing prepared proton exchange resin solution in a proton exchange resin solution tank.
2) Placing prepared electrode slurry in a slurry spraying tank.
3) transferring the stainless steel plate using a roller transportation device to a coating zone, wherein the proton exchange resin solution in the proton exchange resin solution tank is transferred onto the stainless steel plate through a pouring trough, and the proton exchange resin solution is evenly applied on the stainless steel track using a paddle scraper;
4) transferring the stainless steel plate coated with proton exchange resin solution to a heating channel to evaporate a solvent in the proton exchange resin solution to obtain the precursor of the proton exchange membrane;
5) separating the precursor of the proton exchange membrane from the stainless steel plate; transferring the precursor of the proton exchange membrane to a spraying equipment wherein the electrode slurry is sprayed onto both sides of the precursor of the proton exchange membrane;
6) the precursor of the proton exchange membrane with the electrode slurry on both sides is heated and dried to form CCM precursor;
7) immersing the CCM precursor in a NaCl solution, then washing with de-ionized water, and further removing liquid on the surface of the CCM precursor with a water-absorbing roller;
8) heating and drying the CCM precursor in a nitrogen atmosphere; and
9) immersing the CCM precursor in a sulfuric acid solution, washing with de-ionized water, and further removing liquid on the surface of CCM precursor to obtain a CCM electrode with homogenous structure.
said production process of CCM using proton exchange membrane with composite structure comprising:
1) placing the proton exchange resin solution in a proton exchange resin solution tank of a spraying equipment;
2) Placing a prepared diluted proton exchange resin solution in a diluted proton exchange resin solution tank;
3) placing the prepared electrode slurry in an electrode material slurry tank of spraying equipment;
4) affixing a microporous PTFE film on a supporting frame;
5) immersing the supporting frame affixed with the microporous PTFE film in diluted proton exchange resin solution, followed by drying on a hot plate;
6) spraying the proton exchange resin solution evenly on both sides of the microporous film affixed on the supporting frame using the spraying equipment until the thickness of the proton exchange resin of the microporous PTFE film reaches a pre-determined value to obtain the precursor of the proton exchange membrane, wherein the temperature of hot plate is maintained;
7) spraying the electrode slurry onto both sides of the precursor of the proton exchange membrane using electrode slurry spraying equipment until the thickness of an electrode material layer reaches a pre-determined value to obtain the CCM precursor, wherein the temperature of hot plate is maintained;
8) removing the CCM precursor from the supporting frame and immersing it in a NaOH solution, washing with de-ionized water, and removing liquid on the surface to obtain precursor of CCM in a Na⁺ form;
9) heating and drying the CCM precursor in nitrogen; and
10) immersing the CCM precursor in a sulfuric acid solution, washing with de-ionized water, and removing the liquid on its surface to obtain CCM electrode with composite structure.
